(19) United States
(12) Patent Application Publication
(10) Pub. No.: US 2011/0133481 A1
(43) Pub. Date: Jun. 9, 2011

(54) Ecologically Friendly Generator

(76) Inventor: Raymond MULLINS, Abingdon, VA (US)

(21) Appl. No.: 12/917,297

(22) Filed: Nov. 1, 2010

Related U.S. Application Data
(60) Provisional application No. 61/250,676, filed on Oct. 30, 2009.

(51) Int. Cl. H02K 7/18; F01L 7/00

(52) U.S. Cl. 290/1 A; 123/294

(57) ABSTRACT

The present invention relates to the field of generators and engines. Specific embodiments of the invention include a generator comprising: a combustion chamber for combusting fuel to produce a high pressure flow of air or gas; a combustion wheel comprising: a rim with circumferentially spaced combustion plates protruding radially outward from the rim for receiving the high pressure flow of air or gas; a wheel hub providing means for rotating the wheel on an axis of rotation upon interaction of the high pressure flow on the combustion plates; spokes comprising one or more magnets, wherein the spokes operably connect the hub to the rim and provide for the magnets to interact with pick-up coils; pick-up coils for receiving energy from the magnets during rotation of the wheel and for producing electrical energy therefrom; and optionally comprising a battery for receiving and storing energy from the pick-up coils.

### CROSS-REFERENCE TO RELATED APPLICATIONS

This application relies on the disclosure of and claims the benefit of the filing date of U.S. Provisional Application No. 61/250,676, filed Oct. 30, 2009 the disclosure of which is incorporated by reference herein in its entirety.

### BACKGROUND OF THE INVENTION

1. Field of the Invention

The present invention relates to the field of generators.

2. Description of the Related Art

The demand for electricity in all of its forms continues to grow. With today's technology, to use electricity you have to be hooked to the grid (plugged in to an outlet), use a battery or use a portable generator powered by a combustion engine. Generators, and later alternators, have been used in automobiles to provide power generation to charge the battery. Portable generators and alternators powered by a combustion engine are used where electrical power is needed but connection to the grid is not practical and the demand is too great for battery use. Portable power generation equipment is expensive to purchase and to maintain. Proper operation of the equipment depends on a multitude of moving parts, is bulky and heavy. Portable power generating equipment is limited to outdoor use due to the pollutants generated by the combustion engine used to power the generator. Today's portable power generating equipment is inefficient due to the amount of fuel required to move the parts of the engine that provides power to the generator.

### SUMMARY OF THE INVENTION

Embodiments of the invention provide portable electrical power using a generator that is inexpensive to buy and operate, compact, efficient, uses many types of fuel and can be used indoors safely. This invention is simple in design, has very few moving parts, runs on almost any vaporized or gaseous combustible fuel, and can be used indoors when using certain types of fuel.

An object of the invention is to provide portable power generation reliably, cheaply and efficiently with the ability to use ecologically friendly fuels.

Embodiments of the present invention also include a valve for delivering fuel to a combustion chamber comprising: a solid or thick walled hollow cylinder disposed lengthwise on an axis of rotation; a control arm for rotating the solid or thick walled hollow cylinder on the axis of rotation; a hollow passageway through a diameter of the solid or thick walled hollow cylinder; and wherein during operation the passageway of the cylinder can be positioned to provide for or prevent the flow of fuel from a fuel inlet to a combustion chamber through the passageway.

Within the scope of the invention is a generator comprising: a combustion chamber for combusting fuel to produce a high pressure flow of air or gas; a combustion wheel comprising: a rim with circumferentially spaced combustion plates protruding radially outward from the rim for receiving the high pressure flow of air or gas; a wheel hub providing means for rotating the wheel on an axis of rotation upon interaction of the high pressure flow on the combustion plates; spokes comprising one or more magnets, wherein the spokes operably connect the hub to the rim and provide for the magnets to interact with pick-up coils; pick-up coils for receiving energy from the magnets during rotation of the wheel and for producing electrical energy therefrom; and optionally comprising a battery for receiving and storing energy from the pick-up coils.

Also included in the invention is an alternator comprising: a combustion chamber for combusting fuel to produce a high pressure flow of air or gas; a combustion wheel comprising: a rim with circumferentially spaced combustion plates protruding radially outward from the rim for receiving the high pressure flow of air or gas; a wheel hub providing means for rotating the wheel on an axis of rotation upon interaction of the high pressure flow on the combustion plates; spokes comprising one or more electromagnets, wherein the spokes operably connect the hub to the rim and provide for the electromagnets to interact with pick-up coils; pick-up coils for receiving energy from the electromagnets during rotation of the wheel and for producing electrical energy therefrom; and a battery for receiving and storing energy from the pick-up coils and providing energy for operating the electromagnets.

The invention further includes methods, systems, and devices incorporating and/or employing features of embodiments described in this application. It is noted that although only specific embodiments or methods, systems, and devices may be provided, these embodiments can be expanded to cover methods, systems, and/or devices regardless of the type of embodiment is listed. For example, when referring to only a method, such disclosure should be construed to include devices and systems comprising the same elements. Further, these specific embodiments can be altered or modified by omitting one or more elements specifically listed and/or by combining elements of another listed embodiment therewith. For example, if a method embodiment refers to having two method steps, that embodiment can be construed as a system capable of performing only one of those functions and/or as a system capable of performing both of the listed functions and any other function listed for another embodiment. It is within the capabilities of those of ordinary skill in the art to modify this disclosure in this way.

### BRIEF DESCRIPTION OF THE DRAWINGS

FIG. 1 is a schematic diagram of a generator according to the invention.

FIG. 2 is a schematic diagram of a combustion wheel of the invention.

FIGS. 3-5 are schematic diagrams showing various embodiments of a combustion plate according to embodiments of the invention.

FIGS. 6-7 are schematic diagrams showing various embodiments of a combustion head assembly of the invention.

FIG. 8 is a schematic diagram of a combustion head baffle of the invention, showing various views.

FIG. 9 is a schematic diagram of a combustion head side panel of an embodiment of the invention, showing various views.

FIG. 10 is a schematic of a system according to the invention.

FIGS. 11A-B are schematics demonstrating respectively active and default positions of a fuel valve according the invention.

FIGS. 12A-D are schematic diagrams of fuel valves according to the invention.

FIG. 13 is a schematic diagram illustrating a charging system of the invention.

### DETAILED DESCRIPTION OF VARIOUS EMBODIMENTS OF THE INVENTION

In the description of embodiments that follows, the following definitions are used to describe various components described below and in the figures:

TABLE 1
Identification Tags Used in the Drawings

| | |
|---|---|
| 1 | Battery |
| | Any voltage or size of rechargeable battery. |
| | Can be used to store the energy generated by the Pickup Coils 31. |
| 2 | Bridge Rectifier |
| | Converts the alternating voltage/current to direct voltage/current. |
| 3 | Case |
| | The housing used to support the Pickup Coils 31, Trigger Sensor 36, Combustion Wheel |
| | Assembly 14 and Combustion Head Assembly 8. |
| 4 | Charging Section |
| | Can comprise: Pickup Coils 31, Bridge Rectifier 2, Voltage Regulator 37, and Battery 1. |
| 5 | Coil |
| | Develops a high voltage potential to produce a spark from the Igniter 27. |
| | High Voltage Spark Source (HVSS). |
| 6 | Combustion Chamber |
| | Area between Combustion Head Side Panels 10, Combustion Head Baffle 9 and |
| | Combustion Wheel 13. This is the area where combustion occurs. |
| 7 | Combustion Head |
| | Provides a chamber for combustion to occur. |
| 8 | Combustion Head Assembly |
| | The Combustion Head 7 with the Igniter 27 and some of the Control Section components |
| | installed in their possible locations. |
| 9 | Combustion Head Baffle |
| | The middle of three components that are placed together to form the Combustion Head 7. |
| | This component has an opening for the Igniter 27 and a Fuel Passage 21 for fuel to pass into |
| | the Combustion Chamber 6. |
| 10 | Combustion Head Side Panels |
| | The two outside components of Combustion Head 7 are Combustion Head Side Panels. |
| | A Combustion Head Side Panel is on each side of the Combustion Head Baffle 9 to form |
| | the Combustion Head 7 with the Combustion Chamber 6 and Combustion Wheel |
| | Chanel 15. |
| 11 | Combustion Plate |
| | A plate attached to the Combustion Wheel 13. |
| | Combustion forces the Combustion Plate 11 to move which rotates the Combustion |
| | Wheel 13. The Combustion Plates can be flat, dished, spoon shaped or a variation of any of |
| | these. Three basic options are shown. |
| 12 | Combustion Plate Guard |
| | A rail on each side of the Combustion Plates 11, attached to the Combustion Wheel 13. |
| | The Combustion Plate Guard is optional. |
| | The Combustion Plate Guard strengthens and protects the Combustion Plates 11. |
| 13 | Combustion Wheel |
| | Wheel supported by Combustion Wheel Spokes 17 and Combustion Wheel Hub 16. |
| | The Combustion Wheel supports Combustion Plates 11 that are secured to its outer edge. |
| 14 | Combustion Wheel Assembly |
| | The completed assembly of the following; Combustion Wheel Hub 16, Combustion Wheel |
| | Spokes 17, Combustion Wheel 13, Magnets 28, Combustion Plates 11 and the |
| | Combustion Plate Guards 12. |
| 15 | Combustion Wheel Channel |
| | The space between the Combustion Head Side Panels 10 that is not occupied by the |
| | Combustion Head Baffle 9 or the Combustion Chamber 6. |
| | Area where the Combustion Wheel 13 passes between Combustion Head Side Panels 10. |
| 16 | Combustion Wheel Hub |
| | Supports and stabilizes the Combustion Wheel Spokes 17 and the Combustion Wheel 13. |
| | Allows for rotation. |
| 17 | Combustion Wheel Spoke |
| | Combustion Wheel Spokes attach Combustion Wheel 13 to Combustion Wheel Hub 16. |
| 18 | Control Section |
| | A collection of components for initiating/controlling fuel and spark timing for combustion. |
| 19 | Fuel Inlet |
| | A means to attach a fuel supply line to the Fuel Metering Block 20. |
| 20 | Fuel Metering Block |
| | Controls the amount of fuel allowed to pass when the Fuel Valve 23 is open. |
| | Holds the Fuel Valve 23 in place. |
| 21 | Fuel Passage |
| | A hole drilled or cast into the Combustion Head Baffle 9, Fuel Metering Block 20 and Fuel |
| | Valve 23 to allow fuel into the Combustion Head 7. |
| 22 | Fuel Solenoid |
| | Activated by the Relay 32, pulls the Fuel Valve Control Arm25 to put the Fuel Valve 23 |
| | into the open position (active state). |
| 23 | Fuel Valve |
| | A solid or thick walled cylinder with the Fuel Valve Control Arm 24 attached to one end. |
| | There is a Fuel Passage 21 in the Fuel Valve 23 which allows fuel to pass into the |
| | Combustion Head 7 when the Fuel Valve 23 is rotated. |
| 24 | Fuel Valve Control Arm |
| | The Fuel Valve Control Arm is attached to the Fuel Valve 23 and it is used to rotate the |
| | Fuel Valve 23 into the active state and default positions. |
| 25 | Fuel Valve Control Arm Position Sensor |
| | Active (on) when Fuel Valve Control Arm 24 is pulled and goes inactive (off) when the |
| | Fuel Valve Control Arm 24 returns to the default position. |
| 26 | HVSS Gate |
| | Allows the HVSS to pass through to the Igniter 27 for a short time when the Fuel Valve |
| | Control Arm Position Sensor 25 returns to the inactive (off) position. |
| 27 | Igniter |
| | Produces a spark from the HVSS to ignite the fuel. Spark plug. |
| 28 | Magnet |
| | A permanent magnet mounted to the Combustion Wheel Spoke 17. |
| | An electromagnet may be used in place of the permanent magnet. |
| 29 | Main Assembly |
| | The Main Assembly can comprise: Case 3, the Combustion Wheel Assembly 14, |
| | the Combustion Head Assembly 8, the Pickup Coils 31 and the Trigger Sensor 36. |
| | When these components are assembled they become the Main Assembly. |
| 30 | On / Off Switch |
| | Provides power to the system from the Battery 1. |
| 31 | Pickup Coil |
| | Develops voltage/current when Magnets 28 pass by. |
| 32 | Relay |
| | Receives input from Trigger Sensor 36 or Start Switch 35 and activates Fuel Solenoid 22. |
| 33 | Return Spring |
| | Pulls Fuel Valve Control Arm 24 back to default when Fuel Solenoid 22 releases it. |
| 34 | Spark Plug (Igniter) Hole |
| | A hole in the Combustion Head Baffle 9 to accommodate a spark plug (Igniter 27). |
| 35 | Start Switch |
| | Provides the initial trigger to begin the combustion sequence when activated. |
| | Momentary switch that can be operated manually, or automatically by a remote device. |
| 36 | Trigger Sensor |
| | Produces a voltage to activate the Relay 32 which controls the Fuel Solenoid 22 when a |
| | Magnet 28 passes by it. |
| 37 | Voltage Regulator |
| | Reduces and stabilizes the voltage from the Bridge Rectifier 2 to charge the Battery 1. |
| 38 | Inverter |
| | DC to AC inverter-changes the DC output of the Voltage Regulator 37 into 110-240 V AC. |

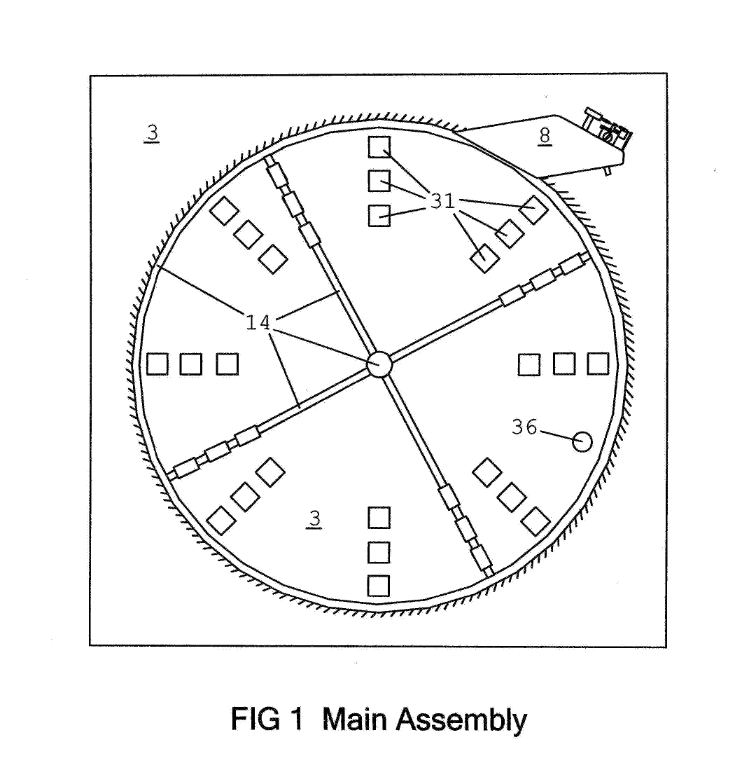

FIG. 1 shows the Main Assembly 29. The view shows a typical configuration for the main parts of the invention. One half of the Case 3 is shown with the Combustion Wheel Assembly 14, the Combustion Head Assembly 8 with some of the Control Section 18 components mounted, the Pickup Coils 31 and Trigger Sensor 36.

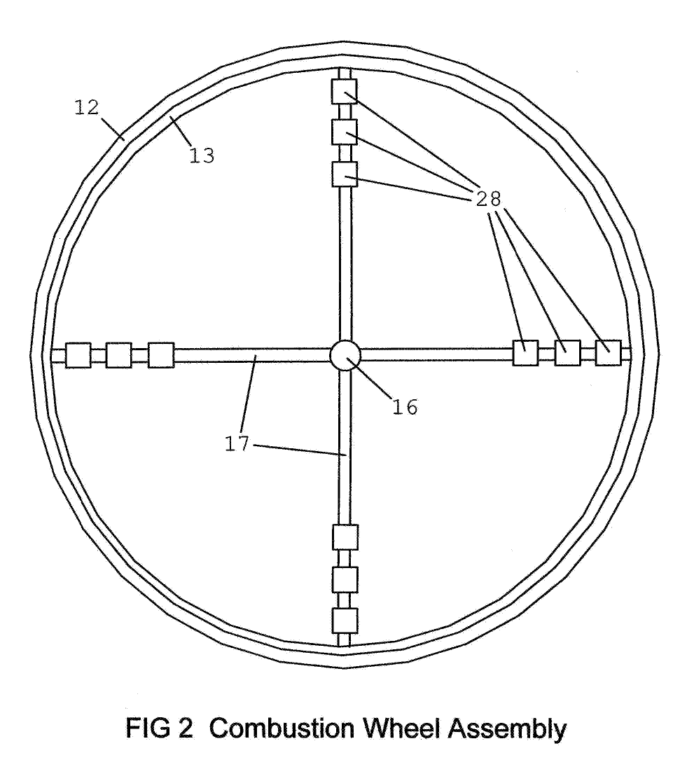

FIG. 2 shows the Combustion Wheel Assembly 14. All of the assembly is shown except the Combustion Plates 11. The Combustion Plate Guard 12 is shown in this view and the Combustion Plates 11 can be seen in FIG. 1 where the Combustion Wheel Assembly 14 is shown without the Combustion Plate Guard 12.

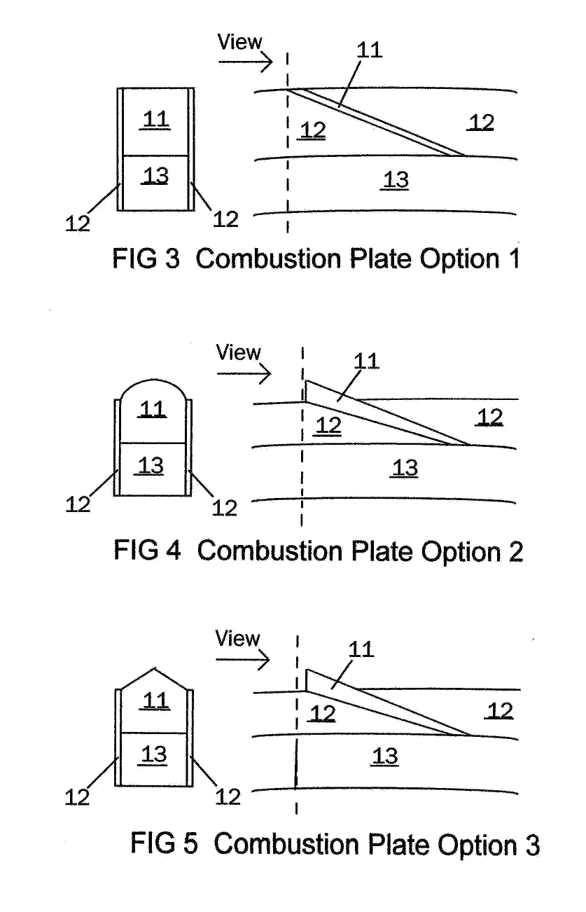

FIG. 3 shows Combustion Plate Option 1. This is the basic configuration for the Combustion Plates 11. The angular relationship between the Combustion Plate 11 and the Combustion Wheel 13 will vary according to the use it is designed for.

FIG. 4 shows Combustion Plate Option 2. It is the same as Combustion Plate Option 1 except that the top of the Combustion Plate 11 extends above the Combustion Plate Guard 12 in a dome or curved shape.

FIG. 5 shows Combustion Plate Option 3. It is the same as Combustion Plate Option 2 except that the portion of the Combustion Plate 11 that extends past the Combustion Plate Guard 12 is squared off into an inverted “V” shape.

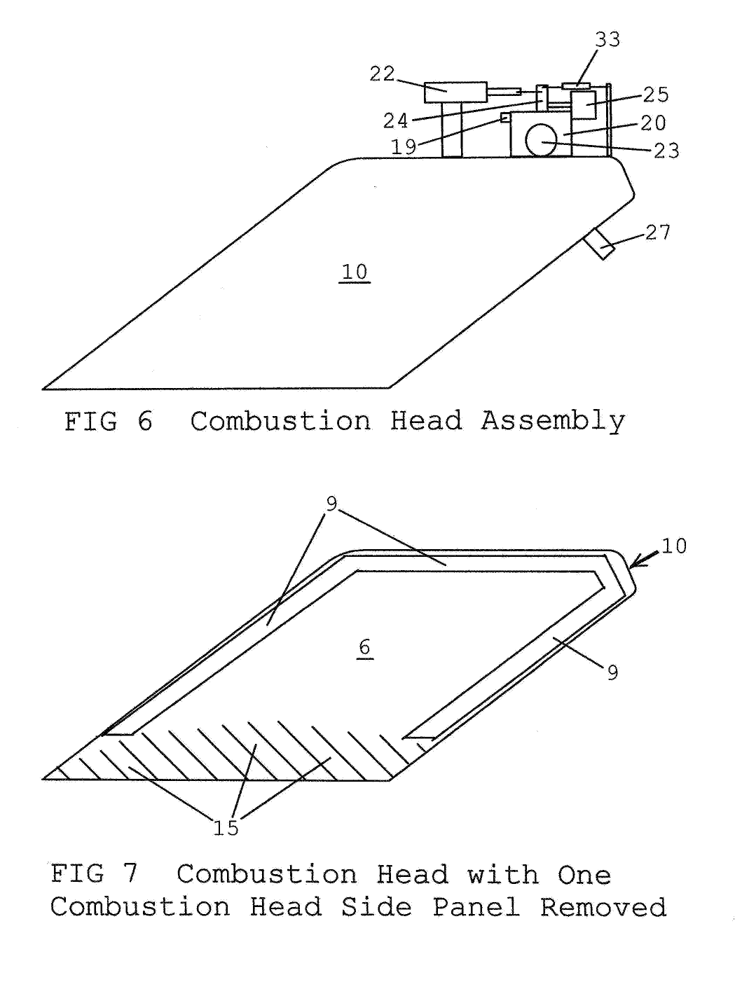

FIG. 6 shows the Combustion Head Assembly 8 which includes some of the Control Section 18 components and the Igniter 27 installed in their possible locations.

FIG. 7 shows the Combustion Head 7 with one Combustion Head Side Panel 10 removed to show the Combustion Head Baffle 9, the Combustion Chamber 6 and the Combustion Wheel Channel 15.

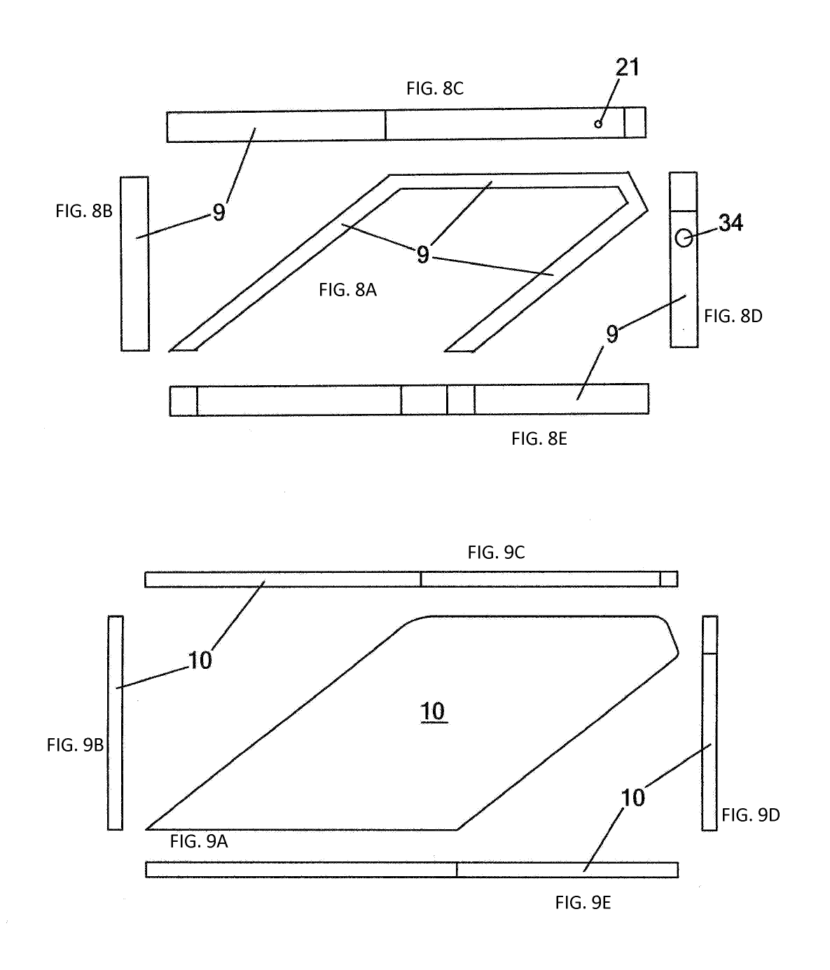

FIG. 8 shows the Combustion Head Baffle—5 Views. The side view of the Combustion Head Baffle 9 is in the center with edge views of each edge shown as if looking at the center view from the position it is in.

FIG. 9 shows the Combustion Head Side Panel—5 Views. The side view of the Combustion Head Side Panel 10 is in the center with edge views of each edge shown as if looking at the center view from the position it is in.

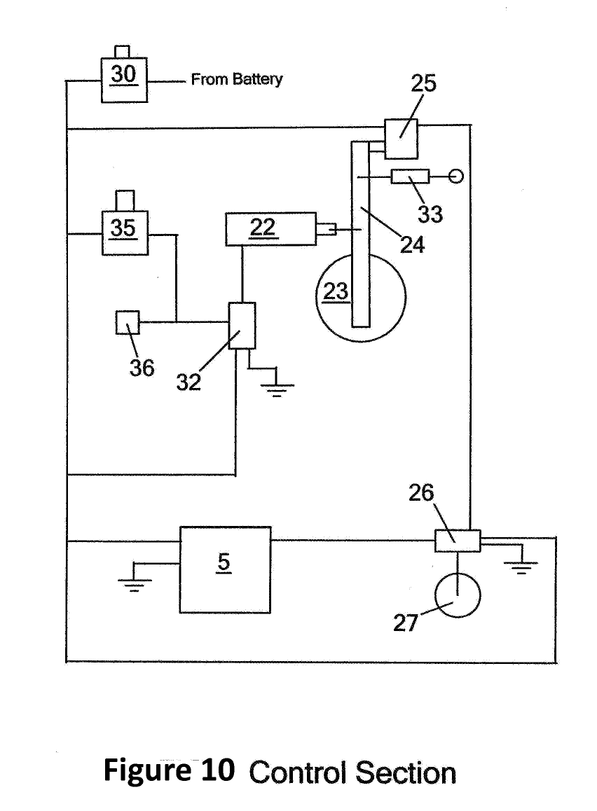

FIG. 10 shows the Control Section 18. The Control Section 18 provides for the control of the power, fuel and spark necessary for combustion.

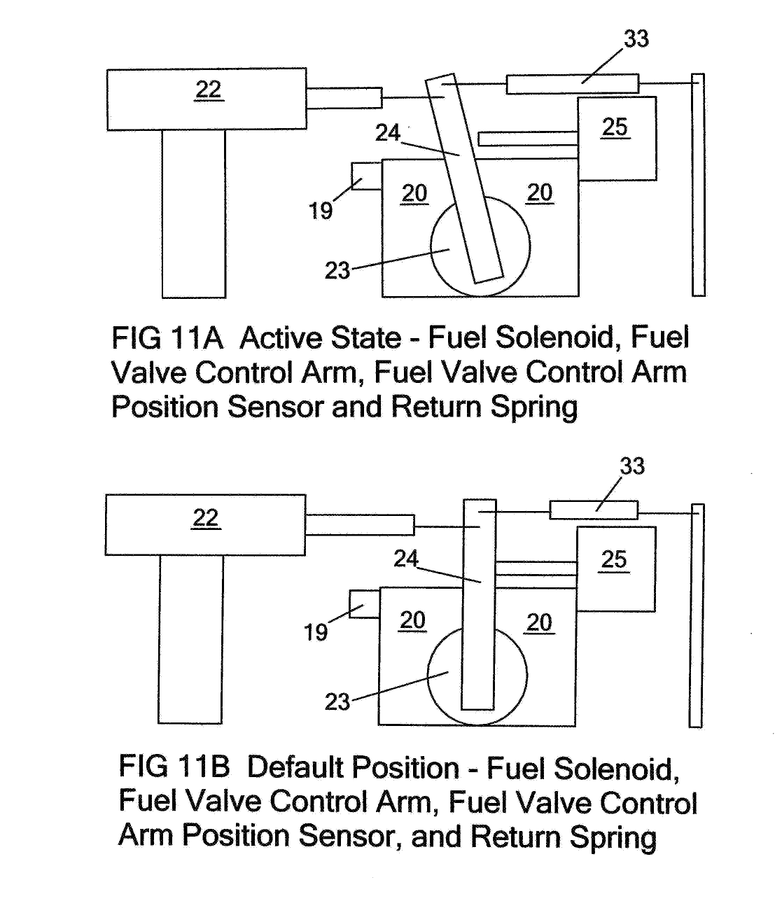

FIG. 11A shows the Active State—Fuel Solenoid, Fuel Valve Control Arm, Fuel Valve Control Arm Position Sensor and Return Spring. This view shows the relative position of these components when in the “active state”.

FIG. 11B shows the Default Position—Fuel Solenoid, Fuel Valve Control Arm, Fuel Valve Control Arm Position Sensor and Return Spring. This view shows the relative position of these components when in the “default position”.

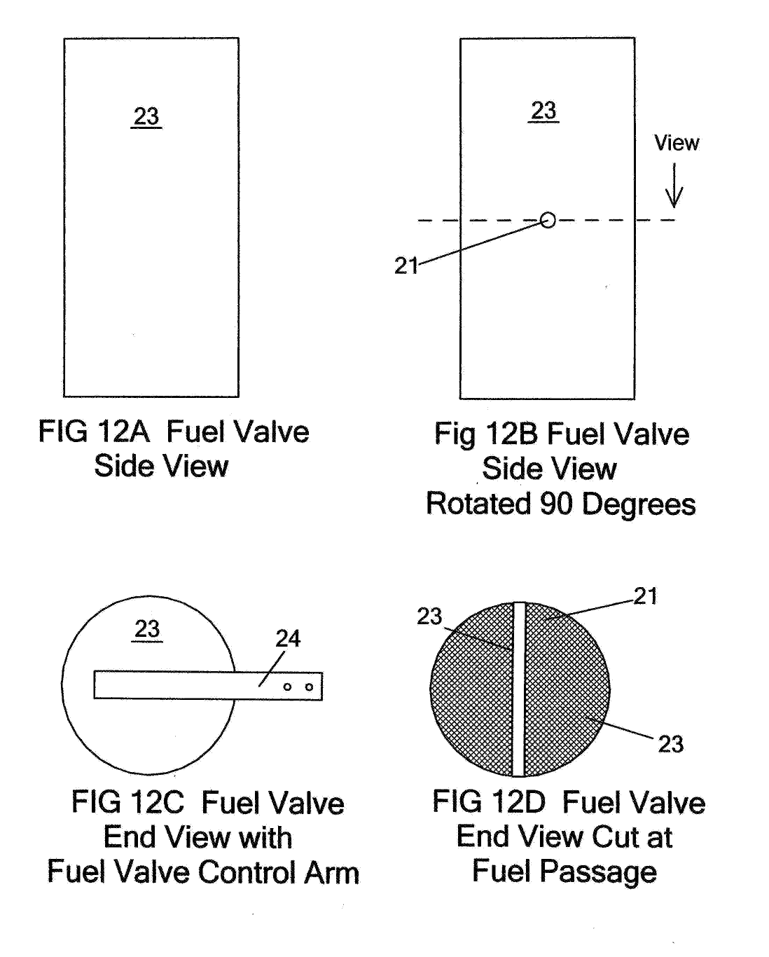

FIG. 12A shows the Fuel Valve Side View. The Fuel Valve 23 is a solid, cylindrical shaped object with a hole drilled or cast into it (Fuel Passage 21). This view is from the side that does not show the Fuel Passage 21.

FIG. 12B shows the Fuel Valve End View with Fuel Valve Control Arm Attached. The Fuel Valve Control Arm 24 is used to rotate the Fuel Valve 23.

FIG. 12C shows the Fuel Valve Side View Rotated 90 Degrees. This view is from the side that shows the Fuel Passage 21 with a cut view indicator for FIG. 12D.

FIG. 12D shows the Fuel Valve End View Cut at Fuel Passage. This view demonstrates how the Fuel Passage 21 passes through the Fuel Valve 23.

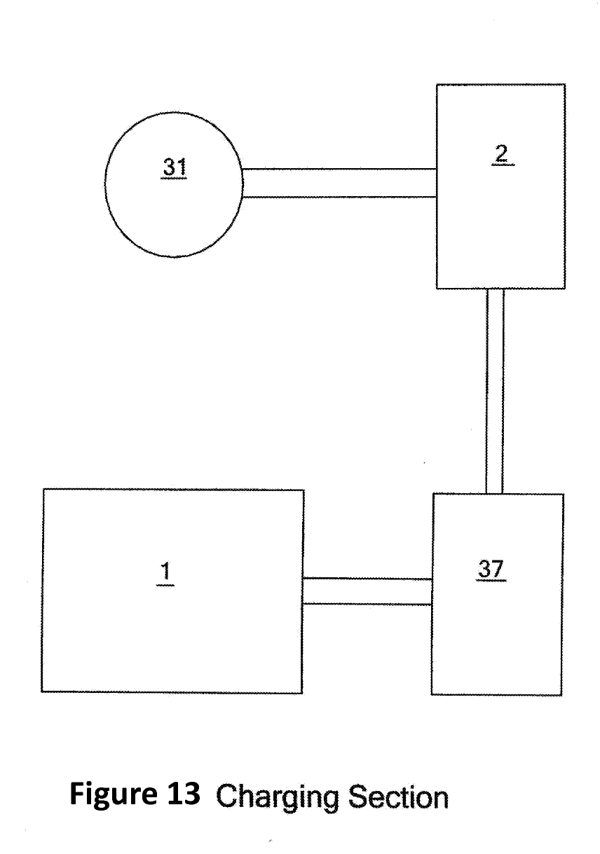

FIG. 13 shows the Charging Section 4. It demonstrates the relationship between the Pickup Coil 31, the Bridge Rectifier 2, the Voltage Regulator 37, the Inverter 38 and the Battery 1.

The Case 3 (shown in FIG. 1) provides for the support of most or all of the components of the generator/alternator. Typically, the following components are mounted in/on the Case 3:

The Combustion Wheel Assembly 14

The Combustion Head Assembly 8

The Pickup Coils 31

The Trigger Sensor 36

The remainder of the components may be mounted on/in the Case 3 or at a remote location. The Case 3 also provides for protection of the components, ventilation, and insulation for sound and temperature. The Case 3, when all of the mountable components are installed, becomes the Main Assembly 29.

The Combustion Wheel Assembly 14 (shown in FIG. 1 and FIG. 2) consists of the following components:

The Combustion Wheel Hub 16

The Combustion Wheel Spokes 17

The Combustion Wheel 13

The Combustion Plates 11

The Combustion Plate Guards 12 (optional)

The Magnets 28 (permanent or electrical)

The view in FIG. 2 shows the Combustion Plate Guard 12 in place which obscures the sight of the Combustion Plates 11. The view of the Combustion Wheel Assembly 14 in FIG. 1 shows the Combustion Plates 11 along the outside of the Combustion Wheel 13. Several options for the configuration of the Combustion Plates 11 are shown in FIG. 3, FIG. 4, and FIG. 5. FIG. 3 shows the basic configuration which is very simple to manufacture and assemble. FIG. 4 shows the curved Combustion Plate 11 extending past the top edge of the Combustion Plate Guard 12 which provides a greater amount of exposure to combustion forces. FIG. 5 shows the Combustion Plate 11 extending past the top edge of the Combustion Plate Guard 12 in an inverted V shape which provides a greater amount of exposure to combustion forces but has the advantage of being easier to manufacture due to a less complicated machining of the Combustion Head Baffle 9 as compared to Combustion Plate 11 of FIG. 4.

The Combustion Head Assembly 8 (shown in FIG. 6) is an assembly of the following components:

The Combustion Head 7, assembled from:

Combustion Head Baffle 9—FIG. 8 and the

Combustion Head Side Panels 10—FIG. 9

The Fuel Inlet 19

The Fuel Metering Block 20

The Fuel Solenoid 22

The Fuel Valve 23

The Fuel Valve Control Arm 24

The Fuel Valve Control Arm Position Sensor 25

The Igniter 27

The Return Spring 33

The areas of the Combustion Head 7 called the Combustion Chamber 6 and the Combustion Wheel Channel 15 are shown in FIG. 7. Combustion occurs in the Combustion Chamber 6 forcing the Combustion Plates 11 to push the Combustion Wheel 13 through the Combustion Wheel Chanel 15. The orientation of the Combustion Head 7 components is shown in FIG. 7. A Combustion Head Side Panel 10 is attached to each side of the Combustion Head Baffle 9 to form the Combustion Head 7. An example of the Combustion Head Baffle 9 is shown in FIG. 8. The side view of the Combustion Head Baffle 9 is shown in the center with the views of the other edges shown adjacent to the viewed area. The Combustion Head Side Panel 10 is shown in FIG. 9. The side view of the Combustion Head Side Panel 10 is shown in the center with the views of the other edges shown adjacent to the viewed area. The general shape of the Combustion Head Baffle 9 shown here is for demonstration purposes. The exact shape of the Combustion Head Baffle 9 and the Combustion Head Side Panel 10 is not critical, so long as the objectives of this invention are still achieved. Indeed, there may be many variations possible, although similar to the example shown. The machining of the Combustion Head Baffle 9 contributes to efficient operation of this invention and is determined by the shape of the Combustion Plate 11 used. The final assembly is best with close tolerances between the Combustion Plate Guards 12 and the Combustion Head Side Panels 10, and between the Combustion Plates 11 and the Combustion Head Baffle 9. These close tolerances are to capture most of the forces of the combustion and cause these forces to rotate the Combustion Wheel Assembly 14.

The Control Section 18 (shown in FIG. 10) consists of the following components:

The On/Off Switch 30

The Start Switch 35

The Trigger Sensor 36

The Relay 32

The Fuel Solenoid 22

The Fuel Valve 23

The Fuel Valve Control Arm 24

The Fuel Valve Control Arm Position Sensor 25

The Return Spring 33

The Coil 5

The HVSS Gate 26

The Igniter 27

The Control Section 18 is responsible for the injection of fuel into the Combustion Chamber 6 and the ignition of the fuel. The active state and default position of the fuel controlling components of the Control Section 18 are shown in FIG. 11A and FIG. 11B. A detailed view of the Fuel Valve 23 is shown in FIG. 12A, FIG. 12B, FIG. 12C, and FIG. 12D. The Fuel Valve 23 comprises one or more Fuel Passage(s) 21. During operation of the generator, fuel is provided through Fuel Inlet 19, into and through Fuel Metering Block 20 (by way of Fuel Passage 21), into and through Fuel Passage(s) 21 of the Fuel Valve 23, into and through the Combustion Head Baffle 9, then into the Combustion Chamber 6. Positioning of Fuel Valve 23 is performed by moving Fuel Valve Control Arm 24, which provides means for rotating the Fuel Valve 23 on an axis of rotation, which lies lengthwise through the center of the valve. Within Fuel Valve 23 is a hollow bore or other passageway for fuel to pass through the valve, preferably perpendicular to the axis of rotation by which Fuel Valve 23 rotates. In preferred embodiments, the passageways through Fuel inlet 19 and Fuel Passage 21 of the Combustion Head Baffle 9 are positioned to allow for minimal movement of Fuel Valve 23 for positioning and aligning Fuel Passage 21 of the valve with the passageways of the inlet and baffle, which will then require small movements of the Fuel Valve Control Arm 24.

Although other embodiments may be designed in accordance with these specifications, especially preferred embodiments of the invention provide a valve for delivering fuel to a combustion chamber comprising a solid or thick walled hollow cylinder having a hollow passageway.

The Charging Section 4 is shown in FIG. 13. The Charging Section 4 contains the following components:

The Pickup Coil 31

The Bridge Rectifier 2

The Voltage Regulator 37

The Battery 1

The Pickup Coil 31 collects energy from passing Magnets 28 which is then turned into direct current by the Bridge Rectifier 2. The energy is then reduced and filtered by the Voltage Regulator 37 and used to charge the Battery 1.

Methods are also included within the scope of the invention. For example, the following is an exemplary sequence of operation:

On/Off Switch 30 is enabled (turned on).

The Start Switch 35 is momentarily enabled causing the Fuel Solenoid 22 to allow a predetermined amount of fuel to enter the Combustion Head 7. At this time the Fuel Valve Control Arm Position Sensor 25 becomes active.

When the Fuel Solenoid 22 releases the Fuel Valve Control Arm 24, the Return Spring 33 pulls the Fuel Valve Control Arm 24 back to the default position and causes the Fuel Valve Control Arm Position Sensor 25 to go inactive.

As the Fuel Valve Control Arm Position Sensor 25 goes inactive, a pulse is generated to the HVSS Gate 26 allowing the HVSS to pass through to the Igniter 27.

The pulse of HVSS to the Igniter 27 causes the fuel to ignite and pushes the Combustion Plates 11 causing the Combustion Wheel 13 to rotate.

As the Combustion Wheel 13 rotates, the Magnets 28 on the Combustion Wheel Spokes 17 pass by the Pickup Coils 31 to produce electrical power. The rotation of the Combustion Wheel 13 also causes the Magnets 28 to pass by the Trigger Sensor(s) 36 causing the Fuel Solenoid 22 to allow a predetermined amount of fuel to enter the Combustion Head 7. At this time the Fuel Valve Control Arm Position Sensor 25 becomes active.

From this point, the sequence of activity represented in paragraphs [00090] through [00093] can be configured to automatically and continuously repeat until the On/Off Switch 30 is deactivated (turned off).

This generator/alternator is designed to use hydrogen as fuel in order to limit the byproducts (emissions) to only water. Other fuels such as methane, propane and gasoline can also be used to power the generator. This design is general in nature to demonstrate the basic principal of operation. Many parts of the generator/alternator will depend on the purpose used and the environment that it is used in. Battery voltage and the type of fuel used are examples of items that affect the components used to construct the generator/alternator.

The examples of the generator/alternator represented here show one Combustion Head Assembly 8, one Trigger Sensor 36, multiple Magnets 28 and multiple Pickup Coils 31. The minimum configuration of the generator/alternator is one Combustion Head Assembly 8, one Trigger Sensor 36, one Magnet 28 and one Pickup Coil 31. Variations include multiple Combustion Head Assemblies 8, multiple Trigger Sensors 36, multiple Magnets 28, and Multiple Pickup Coils 31.

The Fuel Valve 23 is a solid cylindrical object with a Fuel Passage 21. This design allows the Fuel Valve 23 to be exposed to the Combustion Chamber 6. Other combustible devices currently in use have a fuel control valve that is lifted to allow fuel into the combustion area and is shaped so that the combustion force pushes the valve into a depression called a valve seat to prevent combustion forces from flowing back into the fuel source. This generator/alternator rotates the Fuel Valve 23 slightly to align/misalign the Fuel Passage 21 to enable/disable the passing of fuel through the Fuel Valve 23 into Combustion Chamber 6.

Initiating the operation of the generator/alternator can be done manually (as shown) or by a remote switch controlled by some other device. After being started, the generator/alternator will continue operating, without operator intervention, until power is removed from the control section or the fuel is cut off.

Being environmentally friendly, low cost, portable, simple and adaptable are the advantages of device embodiments of the invention. The devices can be made to fit in a case about the size of a large briefcase and most of the parts required are easily manufactured or readily available “off the shelf”. This generator/alternator can be configured for virtually any voltage of battery and can provide multiple DC and AC (with addition of the optional Inverter 38) voltage outputs at the same time. The Case 3 of the generator/alternator will be ventilated to accommodate the environment it is used in and the purpose it is used for.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. It is intended that the specification and examples be considered as exemplary in nature and that variations that do not depart from the essence of the invention are intended to be within the scope of the invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A valve for delivering fuel to a combustion chamber comprising:
a solid or thick walled hollow cylinder disposed lengthwise on an axis of rotation;
a control arm for rotating the solid or thick walled hollow cylinder on the axis of rotation;
a hollow passageway through a diameter of the solid or thick walled hollow cylinder; and
wherein during operation the passageway of the cylinder can be positioned to provide for or prevent the flow of fuel from a fuel inlet to a combustion chamber through the passageway.

2. A generator comprising:
a combustion chamber for combusting fuel to produce a high pressure flow of air or gas;
a combustion wheel comprising:
a rim with circumferentially spaced combustion plates protruding radially outward from the rim for receiving the high pressure flow of air or gas;
a wheel hub providing means for rotating the wheel on an axis of rotation upon interaction of the high pressure flow on the combustion plates;
spokes comprising one or more magnets, wherein the spokes operably connect the hub to the rim and provide for the magnets to interact with pick-up coils;
pick-up coils for receiving energy from the magnets during rotation of the wheel and for producing electrical energy therefrom; and
optionally comprising a battery for receiving and storing energy from the pick-up coils.

3. An alternator comprising:
a combustion chamber for combusting fuel to produce a high pressure flow of air or gas;
a combustion wheel comprising:
a rim with circumferentially spaced combustion plates protruding radially outward from the rim for receiving the high pressure flow of air or gas;
a wheel hub providing means for rotating the wheel on an axis of rotation upon interaction of the high pressure flow on the combustion plates;
spokes comprising one or more electromagnets, wherein the spokes operably connect the hub to the rim and provide for the electromagnets to interact with pick-up coils;
pick-up coils for receiving energy from the electromagnets during rotation of the wheel and for producing electrical energy therefrom; and
a battery for receiving and storing energy from the pick-up coils and providing energy for operating the electromagnets.
